(19) United States
(12) Patent Application Publication
(10) Pub. No.: US 2025/0335941 A1
(43) Pub. Date: Oct. 30, 2025

(54) Multiple Time Series Forecasting

(71) Applicant: Ikigai Labs, Inc., San Francisco, CA (US)

(72) Inventors: Devavrat Dilitkumar Shah, Newton, MA (US); John Tsitsiklis, Lexington, MA (US); Nathaniel Clinton Lanier, Boston, MA (US); Abdullah Alomar, Oakland, CA (US); Arth Dharaskar, Somerville, MA (US)

(21) Appl. No.: 18/649,002

(22) Filed: Apr. 29, 2024

(51) Int. Cl. G06Q 30/0202

(52) U.S. Cl. CPC G06Q 30/0202

(57) ABSTRACT

An approach for forecasting multiple related data series includes first determining individual forecasts for different items or groups of items and/or over different time sequences or granularities. These first forecasts are then reconciled to form second forecasts that satisfy relationships between the data series while best approximating the first forecasts.

### BACKGROUND OF THE INVENTION

This invention relates to reconciliation of time series estimates, for example, forecasts of future time series values when such time series estimates may have different granularities in time and/or different granularities or groupings of the underlying quantities being estimated or forecasted.

Forecasting has many practical applications. One such application is in supply chain management, for example, in retail situations. Forecasting demand resulting from sales of different items can feed directly into making demands of a supply chain to provide the items that are predicted to be in demand. In some practical applications, the forecasts may automatically cause the supply orders to be made to satisfy the forecasted demand, thereby avoiding or limiting the need for a human to be in the loop.

A wide variety of forecasting techniques are available for using existing values of a quantity at points or intervals in time (“time series measurements”), and extrapolating future values of that quantity. Most typically, the existing values and future values are associated with sequential time indices, such as the number days or weeks from an origin day. Some such techniques may be tolerant of missing samples in the existing data. Without being limited to any particular domain, in a retail domain an example of a quantity may be the number of women's shirts sold on a particular day, and using a history of the number of women's shirts sold each day for the previous year, a forecast technique may estimate the expected number of shirts that will be sold on each day of the coming year. Some forecasting techniques may also provide a measure of uncertainty of the forecast values, for example, as a standard deviation of the true value around the forecast value, or in probability terms as a probability distribution (e.g., a Normal distribution) for a forecast value or the deviation of the true value from the forecast value (e.g., a “prediction error”), possibly accounting for correlation between prediction errors at different times.

In many practical situations, there are a number of related quantities that may be forecasted. For example, in the retail domain, separate forecasts may be made for women's shirts and for men's shirts. While a forecast for shirts (whether men's or women's) might be made by summing the forecasts, a direct forecast may also be made using an available technique. It should be recognized that if a separate forecast is made for shirts, such a forecast is not necessarily equal to the sum of the men's and women's forecasts. Similarly, if shirts may be categorized as t-shirts and button-shirts, then while one may have forecasts for men's t-shirts and women's t-shirts separately from a forecast for t-shirts as a whole, the forecasts are not necessarily self-consistent.

Also in many practical situations, there may be different time scales under which forecasts are made. While a day-by-day forecast may be useful for some purposes, the same quantity may be forecasted on a weekly or monthly basis as well. As with the categorization, if separate monthly forecasts for the quantity of shirts that will be sold is made, this estimate is not necessarily the sum of the daily forecasts in that month.

There is a need to be able to forecast quantities representing different groupings of underlying items or quantities and/or different time scales of sampling so that the forecasts are self-consistent.

### SUMMARY OF THE INVENTION

In one aspect, in general, an approach for forecasting multiple related data series includes first determining individual forecasts for different items or groups of items and/or over different time sequences or granularities. These first forecasts are then reconciled to form second forecasts that satisfy relationships between the data series while best approximating the first forecasts.

In another aspect, in general, a method involves forecasting a plurality of data series. The method includes determining first forecasts, processing relationship information and determining a set of data series requirements from the relationship information, and then determining second forecasts to satisfy data series requirements and to best approximate the data series of the first forecasts according to a similarity criterion. The first forecasts comprise a plurality of data series, wherein each data series of said plurality is associated with (a) an item or a group of items, and (b) a time sequence in which each item in the time sequence represents a time or an interval. This plurality of data series includes multiple data series associated with different items or groups of items, or include multiple data series associated with different time sequences. The relationship information represents a plurality of relationships, with each relationship relating the items or groups of items or relating time sequences of different of the data series of a forecast. This plurality of relationships includes at least one of a first time relationship associating elements of a first time sequence with elements of a second time sequence, and a first group relationship associating a first group of items with multiple other groups or items. The processing of the relationship information includes forming a data representation of each relationship, and then determining a set of data series requirements based on the received relationship information, the data series requirements including at least a first data series requirement relating a first set of data series to a second set of data series over times or intervals for a time sequence associated with said first and second sets of data series, and a second data series requirement relating values of multiple data series for each time or interval of a time sequence. The second forecasts comprise a plurality of data series, wherein each data series of said second forecasts is associated with (a) an item or a group of items, and (b) a time sequence in which each item in the time sequence represents a point or an interval. The determining of the second forecasts includes executing a data processing procedure on a computer processor to determine the data series of said second forecasts based on the data series of the first forecasts and based the data representations of the relationships, the data processing procedure being configured for the data series of the second forecasts to satisfy the plurality of relationships and to best approximate the data series of the first forecasts according to a similarity criterion.

Aspects can include one or a combination of any of the following features.

Determining the first forecasts comprises collecting historical data comprising measurement data for a plurality of items or a group of items at one or more time sequences; and applying at least one forecasting data processing procedure to the collected historical data to yield the first forecasts.

The second forecasts are used to affect operation of a system involving the plurality of items or groups of items. For instance, the items comprise retail items, and the second forecasts are used to affect operation of a supply chain system involving said items.

The plurality of relationships include both the first time relationship and the first group relationship.

A first input data series plurality of input data series comprises values representing a number of an item or a group of items associated with said data series for each time or interval of the time sequence associated with said data series.

The time sequences associated with the data series includes a first time sequences comprising a sequence of calendar intervals. For instance, the calendar intervals comprise days, weeks, months, or years.

The relationship information comprises a plurality of linear relationships between values of the data series.

The plurality of linear relationships include at least one of (a) a requirement that a value of a first data series for a group of items at a particular time in a time sequence is equal to a sum of values of a second plurality of data series for items in the group of items at that particular time, and (b) a requirement that a value of a third data series for an item or group of items at a particular time in a third time sequence is equal to a sum of values in a fourth data series for said item or group of items for a plurality of times in a fourth time sequence associated with said particular time.

The set of data requirements comprises one or more matrix representations of said requirements.

Determining the second forecasts comprises using an optimization procedure. For instance, using the optimization procedure comprises using a Quadratic Programming procedure.

In another aspect, in general, a method for forecasting comprises executing one or more data processing procedures to form independent forecasts including at least one of (a) a first plurality of forecasts for a respective a plurality of overlapping subsets of a plurality of items and (b) a second plurality of forecasts for a respective plurality of overlapping time points or intervals. A data representation of forecast constraints resulting from relationships arising from at least one of the overlapping subsets of the plurality of items and the overlapping time points or intervals is formed. A reconciliation data processing procedure is executed to process the independent forecasts and the data representation of the forecast constrains to form reconciled forecasts satisfying the forecast constraints and approximating the independent forecasts. In some examples, the independent forecasts include both (a) the first plurality of forecasts and (b) the second plurality of forecasts. In some examples, the reconciliation data processing procedure comprises an optimization procedure for reducing a difference between the independent forecasts and the reconciled forecasts. For instance, the forecast constraints are linear constraints and the optimization procedure comprises a Quadratic Programming procedure. Executing the one or more data processing procedures to form the independent forecasts may comprise executing one or more of regression, moving average, and neural network-based procedures.

Other features and advantages of the invention are apparent from the following description, and from the claims.

### BRIEF DESCRIPTION OF THE DRAWINGS

FIG. 1 is data flow diagram of a forecasting procedure.

### DETAILED DESCRIPTION

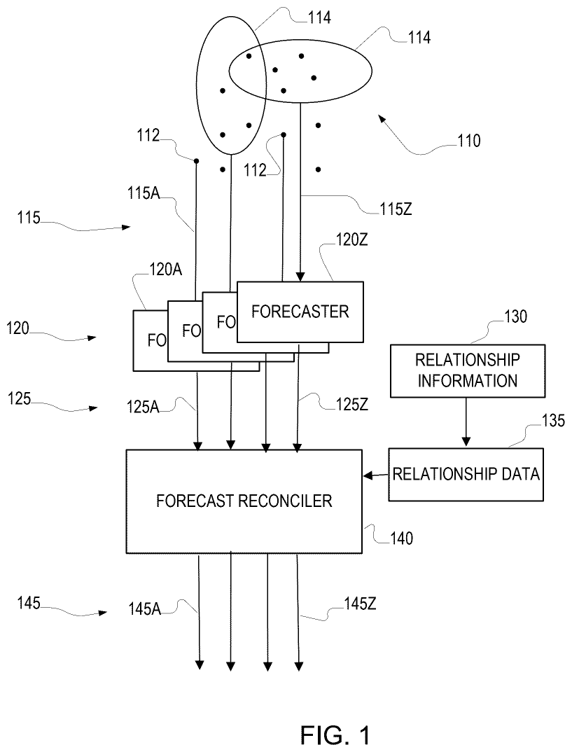

Referring to FIG. 1, a forecasting procedure is used to determine forecasts for values associated with a number of items and groups of items. In FIG. 1, each distinct item 112 is represented by a dot, and groups of items are represented by enclosing curves 114. An exemplary application of this procedure is in a retail situation where each item 112 represents a different item being sold. In such an exemplary application, there may be a large number of different items that are for sale (e.g., distinct Stock Keeping Units, SKU). The SKUs may be arranged in a hierarchy, such as Clothing at the top of such a hierarchy, Shirts, Pants, Shoes, etc. at a second level of the hierarchy below Clothing, and T-shirts, button-shirts, etc. at third level of hierarchy below Shirts. More generally, there may not be a single such hierarchy because Clothing might also be divided into Men's Clothing and Women's clothing. Therefore, there may be a wide variety of categories or groups of SKUs that might be considered separately.

In FIG. 1, historical data 115 is collected for the items, with distinct histories 115A-Z (i.e., sequences or series of values associated with corresponding times or intervals in a time sequence) being collected for different items and groups of items. In some cases, such histories may be collected using technical means, for example, being produced by electronic systems recording sales as they are made or stored and later retrieved from a database system. However, any of a variety of approaches for collecting the historical data 115. As an example, historical data for a particular item may have a value measured for it on each day, for example, representing the number of that item sold on that day, or the monetary value of the sales of that item on that day.

Not only may different historical data 115A-Z correspond to different items or groups of items, different historical data may be measured at different times (i.e., using different time sequences). For example, one historical data may be measured on a time sequence representing a measured value once a day, while another historical data may be measured on a time sequence representing once a week or once a month. The same item or group of items may yield multiple data histories on different time sequences.

The forecasting of the quantities in the retail example may be tied to a practical application such as inventory control and ordering. For example, if the sales are actively measured in a retail enterprise, then forecasts for future sales may be made to automatically replenish stock for forecasted future sales. Therefore, the forecasting approaches described herein are not merely business concepts, they may be coupled to the management of physical quantities—the number of items in stock available for sale. A closed loop inventory control system may have automated means for measuring sales, and automated forecasting approach as described herein, and an automated supply management system that makes orders according to the forecasts.

The historical data 115 is processed by forecasters 120, with each of the distinct history 115A-Z being processed by a separate forecaster 120A-Z, respectively. Various types of forecasters may be used, and multiple histories may be processed with the same type of forecaster. The approaches describe in this document are not limited to particular types of forecasters. Examples of forecasters may use polynomial regression, autoregressive moving average (ARMA) models, and various types of machine-leaning models (e.g., recurrent neural networks). The forecasters are in general implemented as software controlled data processing procedures executing on general purpose computers, possibly using integrated special-purpose processors, such as Graphics Processing Units (GPU) for accelerating the data processing.

The output of the forecasters 120 is a set of forecasts 125, generally with one forecast 125A-Z corresponding to a particular forecaster 120A-Z that processed particular historical data 115A-Z, respectively. Each forecast 125A-Z includes a sequence of values at times on intervals in a corresponding time sequence. Generally, these times are in the future relative to corresponding data histories. However, more generally the “forecast” may also represent values during times when the data histories were collected, and the forecasting may be used to determine missing data values, or to correct of modify data values that were collected. In some cases, the “forecast” is a combination of historical data and predicted data. As with the historical data, the forecasts may be stored and later retrieved from a database system.

Returning to the retail example, a forecast of Women's Clothing as well as a forecast of the overlapping grouping of Shirts may both be useful. Below we refer to such groups as SKU Groups, or SKUG. To simplify the discussion below, forecasts are made for the various SKUG (permitting a SKUG to have an individual SKU if forecasting is made at such a granular level). Therefore, there may be a wide variety of categories or groups of SKUs that might be considered separately. To simplify the discussion below, forecasts are made for the various SKUG (permitting a SKUG to have an individual SKU if forecasting is made at such a granular level). There may be yet other groupings, for example, by store, and by state (a hierarchical grouping), but possibly by overlapping groups such as companies (e.g., TJMax, Marshalls, Homegoods, etc., all within the TJX retail enterprise). While the examples below focus on SKU groups, such other groupings may be handled in exactly the same manner.

As illustrated in FIG. 1, each forecaster 120A-Z generally works independently. Therefore, the forecasts for items and groups containing those items, or forecasts for a particular item on different time sequences, are not necessarily self-consistent. To be self-consistent, the forecasts should obey certain relationships, which in FIG. 1 are illustrated as relationship information 130. One type of a relationship may relate to the grouping of items. For example, such a relationship might be articulated as the value of the forecast for a particular group of SKUs (a SKUG) at any particular time must equal the aggregate (e.g., the sum or average) of the values of the forecast for each of the SKUs in that SKUG at that particular time. Another type of relationship may relate to different forecast time sequences for a particular item or group of items. For example, such a relationship might be articulated as the value of a forecast for any time at a particular time interval of one time sequence, such as a week, must be the aggregate (e.g., sum or average) of the values of the forecast for all the times in another time sequence in that interval. For example, if one forecast is at a weekly time scale with each value representing, for example, sales of an item for an entire week, that value should be equal to the sum of the values for the daily forecasts for all the days in that week. In FIG. 1, such relationships are transformed into relationship data 135, which encodes all of these relationships in a form that is amenable to automated data processing described further below.

Continuing to refer to the retail example, quantities may be recorded at several different time scales or granularities (i.e., on different time sequences), for example, on a daily, monthly and annual time scales. In a first time of set of time scales, there is a natural hierarchy: a value of a quantity for a year is the aggregate by summation of the quantity for the previous 12 months; the value for a month is the sum of the quantities for the previous days of that month. Some sets of time scales are not strictly hierarchical, for example, if quantities are also measured on a weekly basis. In such a case, each week has a specific set of days in it, but months or years are not made up of an exact set of weeks. If forecasts are made, for example, at day, week, month, and year intervals, then the forecasts at the different scales should be naturally consistent in the same way that the forecasts for different groups of SKUs should be consistent. As with the groupings of SKUs, it is not necessary to make forecasts at all time scales. For example, forecasts may omit the Day timescale, but the forecasts for Week and Month must nevertheless be self-consistent in that there must be possible forecasts at the Day scale that would yield the Week and Month values.

A forecast reconciler 140 implements a data processing procedure that takes as input the possibility inconsistent forecasts 125A-Z and uses the relationship data 135 to compute and output a set of self-consistent forecasts 145A. In some examples, the procedure strictly enforces the relationships in the relationship information 130 and its data representation in the relationship data 135, and as best as possible matches the forecasts 125A-Z. In other examples, there is a tradeoff between enforcing the relationships as closely as possible and matching the forecasts as closely as possible and certainly more closely than the unprocessed forecasts 125A-Z.

Turning now to one implementation, which of course is applicable to the retail example, the approach may be explained through use of mathematical and/or data array notation. This notation is used to specify data manipulations as would be implemented by a computer programmer, and therefore the mere use of mathematical notation does not necessarily connote the use of abstract mathematical concepts. Rather the notation is used to provide specificity of the data manipulations that are to be used.

The underlying forecasters yield data of the form x[c, n, s] where c is the item (e.g., a SKU) or a group (e.g., a SKUG, such as Clothing, Men's Button Shirts, etc.), n is a time index for the forecast, and s indicates the time scale (e.g., Day, Week, Month, etc.). For each group, there is a set of underlying SKUs that make up that group, which can be represented as the set [symbol] (c), where when c is an underlying SKU we simply have a set of one element [symbol] (c)={c}. Turning first to the consistency between groups and the underlying SKUs, in a fully reconciled forecast, at each item c at a time index n at a particular time scale s, the forecasts must satisfy a relationship

$$x [ c , n , s ] = {\sum }_{{c}^{′} ∈ 𝒢 ( c )} x [ {c}^{′} n , s ] .$$

That is, if there are G total number of forecasted SKUGs (i.e., not single SKUs) and there are a total of T different time indices (n, s) across the various time scales/granularities, then a reconciled set of forecasts would satisfy GXT linear relations.

Similarly, a fully reconciled set of forecasts would be consistent in the time dimension. As with the grouping of items, each point in time at a particular time scale, denoted [n, s] is made up of a set of the smallest time units (which we denote as the s=0 timescale), which we denote [symbol] (n, s). Therefore, at each item c at a time index n at a particular time scale s, the forecasts must satisfy a time relationship

$$x [ c , n , s ] = {\sum }_{{n}^{′} ∈ ℐ ( n , s )} x [ c , {n}^{′} , 0 ] .$$

That is, if there are S different time indices at time scales longer than the smallest time unit, and there are a total of C items (SKUs and SKUGs), then a reconciled set of forecasts would satisfy S×C linear relationships.

Because the unreconciled forecasts x[c, n, s] do not generally satisfy the constraints, the procedure yields reconciled forecasts y[c, n, s] that are close in the sense that for “errors” defined as e[c, n, s]=y[c, n, s]−x[c, n, s] are minimized in aggregate, in particular as a sum of squared errors

$$E = {\sum }_{( c , n , s )} {e [ c , n , s ]}^{2}$$

Note that for the fixed unreconciled forecasts x[n, c, s], the overall error E is a quadratic function of the individual forecasts y[c, n, s] that are to be determined. As discussed above, there are a total of G×T+C×S linear relationships (e.g., constraints) on the reconciled forecasts. There are a number of computationally efficient procedures for determining the reconciled forecasts subject to this overall error and linear relationships. One such procedure is an optimization procedure referred to as “Quadratic Programming”. Cases in which there is an additional requirement that some or all of the forecasts are integers (e.g., number of units rather than dollars), then a variant of such a procedure referred to as “mixed integer quadratic programming” may be used.

As introduced above, it is useful to represent the relationship information 130 in a data form 135 that is easily processed by the forecast reconciler 140. In particular the relationships are represented as an array of numbers (i.e., a “matrix”), and then the relationships can be represented in mathematical terms as matrix multiplication constraints. For example, the linear constraint associated with a particular SKUG c may be represented as a multiplication of a row vector.

$${b}_{c}^{T} Y = {\underline{0}}^{T}$$

where 0 is a column vector of all zeros. All the constrains for the different SKUGs can be combined (i.e., concatenated next to one another) in one matrix so that all the SKU group constraints are represented as B^{T}Y=0, where 0 is a G×T matrix of all zeros. Equivalently, these constraints may be represented as Y^{T}B=0. Similarly, a constraint for a particular time index (n, s) can be represented as a matrix-vector multiplication Ya_{(n,s)}, and all the time constraints can be represented as a matrix multiplication YA=0, where 0 is a C×S matrix of all zeros. Such a matrix formulation may be useful for setting up certain other computational procedures.

In some implementations, not all errors between an unreconciled forecast and a reconciled forecast are treated equally, and very generally, the overall error may be weighted as E=Σ_{(c,n,s)}w[c, n, s]e[c, n, s]². These weights may be determined in various ways. For example, the weights can be set manually to depend only on the time scale s, or on the combination for the SKUG and the scale (c, s), or on any combination of c, n, and s. As another example, the weights can depend on sizes of the sets of fines times and SKUs, for example, as the inverse of the product of the sizes, w[c, n, s]=(| [symbol] (c)∥ [symbol] (n, s)|)⁻¹. In some implementations, the weights may be determined from the individual forecasters, for example, with each provided unreconciled forecast value having an estimate (e.g., mean) x as well as a standard deviation (e.g., or variance σₓ²) of the value. For example, in the case of the forecaster providing the variance, the weights may be set as the inverse of the variance. In some examples, correlation of the errors between different time samples at a particular scale, between different time scales, and between different levels of grouping of SKUs may be determined and then this correlation may be used to determine a most probable (e.g., maximum likelihood) set of reconciled forecasts by modifying the overall error formula.

In the discussion above, the form of the computation essentially assumes that all the unreconciled forecasts for all time indices at all time scales are available and correspond to the same number of reconciled forecasts. Missing forecasts, for example, with individual values being missing is addressed by essentially omitting the missing forecasts in the summation forming the overall error E. The constraints on the reconciled forecasts are not affected by missing unreconciled forecasts, therefore having modified the overall error, the procedure such as quadratic Programming can be applied as before.

Note that the formulation of the processing of unreconciled forecasts to form reconciled forecasts using quadratic programming is not the only available approach. Other approaches include treating the unreconciled forecasts as “noisy” observations of the true reconciled forecasts and using a Kalman Filter (i.e., as a Kalman Smoother), or a multi-scale formulation of a Kalman filter, for determining the reconciled forecasts from the hidden state sequence. As another alternative to the quadratic programming approach, a graph-based belief propagation algorithm (e.g., with one node per forecast value) may be used to iteratively determine the best reconciled forecasts. Yet other approaches include interactively updating the forecast values (e.g., one SKU and time point at a time) to approach fully reconciled values. Yet other computational approaches are possible.

As introduced above, the retail application is only one specific use of these techniques. Other examples may include forecasting crop yields at various time scales and various groupings of crops, and the forecasting of house price changes at different time scales and geographic scales (town, county, etc.). In finance, the approach can help investors make more informed decisions by forecasting stock market trends and predicting future prices. It can also be used to predict economic indicators, such as GDP or inflation, and assist businesses in making financial planning and strategic decisions. In the healthcare industry, the approach can be used to forecast patient demand for medical services and resources, thus improving the allocation of resources and planning for potential surges in demand. In the field of energy, the approach can forecast future energy demand and assist in planning for renewable energy resources. It can also help identify potential supply and demand imbalances in the energy market.

Implementations of the approaches described above may make use of software, including non-transitory machine-readable media with instructions stored on the media. These instructions may be executed by physical processors, such as physical general-purpose processors and/or special-purpose computation processors such as Graphics Processing Units (GPUs), Tensor Processing Units, and the like, or executed by virtual processors (e.g., a Java Virtual Machine), with the virtual processor being in turn implemented using instructions that execute on a physical processor. Some implementations may make use of special-purpose hardware (e.g., FPGAs or ASICs) to perform some of the data manipulation described above.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for forecasting a plurality of data series, the method comprising:
determining, as output from a plurality of independent forecasters, first forecasts comprising a plurality of respective data series,
wherein each data series of said plurality is associated with (a) an item or a group of items, and (b) a time sequence in which each item in the time sequence represents a time or an interval,
wherein said plurality of data series includes multiple data series associated with different items or groups of items, or include multiple data series associated with different time sequences, and
wherein the multiple data series includes
a first data series for a first item or group of items in which data items in said series are associated with respective times or time intervals in a first time sequence,
a second data series for the first item or group of items in which data items in said series are associated with respective times or time intervals in a second time sequence, wherein times or time intervals in said second time sequence being each associated with multiple times or time intervals in said first time sequence, and
a third data series for a second item or group of items in which data items in said series are associated with respective times or time intervals in the first time sequence, wherein the first item or group of items and the second item or group of items are distinct and share at least one item;
processing relationship information representing a plurality of relationships, with each relationship relating the items or groups of items or relating time sequences of different of the data series of a forecast, the plurality of relationships including:
a first time relationship associating elements of a first time sequence with elements of a second time sequence, including associating each element of the first time sequence with respective multiple elements of the second time sequence, and
a first group relationship associating a first group of items with multiple other groups or items, the first group relationship identifying the at least one item shared between the first item or group of items and the second item or group of items,
the processing including forming a data representation of each relationship;
determining a set of data series requirements based on the received relationship information, the data series requirements including at least a first data series requirement relating a first set of data series to a second set of data series over times or intervals for a time sequence associated with said first and second sets of data series, and a second data series requirement relating values of multiple data series for each time or interval of a time sequence;
processing the plurality of data series of the first forecasts to determine second forecasts comprising a plurality of data series comprising a reconciled first data series, a reconciled second data series, and a third reconciled data series corresponding to the first data series, the second data series, and the third data series, respectively,
wherein each data series of said second forecasts is associated with (a) an item or a group of items, and (b) a time sequence in which each item in the time sequence represents a point or an interval,
the determining of the second forecasts including executing a data processing procedure on a computer processor to determine the reconciled data series of said second forecasts based on the data series of the first forecasts and based the data representations of the relationships, the data processing procedure being configured for the reconciled data series of the second forecasts to satisfy the plurality of relationships and to best approximate the data series of the first forecasts according to a similarity criterion.

2. The method of claim 1, wherein determining the first forecasts comprises:
collecting historical data comprising measurement data for a plurality of items or a group of items at one or more time sequences; and
applying at least one forecasting data processing procedure to the collected historical data to yield the first forecasts.

3. The method of claim 2, further comprising:
using the second forecasts affect operation of a system involving the plurality of items or groups of items.

4. The method of claim 3, wherein the items comprise retail items, and the second forecasts are used to affect operation of a supply chain system involving said items.

5. (canceled)

6. The method of claim 1, wherein a first input data series plurality of input data series comprises values representing a number of an item or a group of items associated with said data series for each time or interval of the time sequence associated with said data series.

7. The method of claim 1, wherein the time sequences associated with the data series includes a first time sequences comprising a sequence of calendar intervals.

8. The method of claim 7, wherein the calendar intervals comprise days, weeks, months, or years.

9. The method of claim 1, wherein the relationship information comprises a plurality of linear relationships between values of the data series.

10. The method of claim 9, wherein the plurality of linear relationships include at least one of (a) a requirement that a value of a first data series for a group of items at a particular time in a time sequence is equal to a sum of values of a second plurality of data series for items in the group of items at that particular time, and (b) a requirement that a value of a third data series for an item or group of items at a particular time in a third time sequence is equal to a sum of values in a fourth data series for said item or group of items for a plurality of times in a fourth time sequence associated with said particular time.

11. The method of claim 9, wherein determining the set of data requirements comprise one or more matrix representations of said requirements.

12. The method of claim 9, wherein determining the second forecasts comprises using an optimization procedure.

13. The method of claim 12, wherein using the optimization procedure comprises using a Quadratic Programming procedure.

14. A non-transitory machine-readable medium having instructions stored thereon, the instructions when executed by a data processing system cause said system to perform operations including:
determining first forecasts comprising a plurality of data series,
wherein each data series of said plurality is associated with (a) an item or a group of items, and (b) a time sequence in which each item in the time sequence represents a time or an interval, and
wherein said plurality of data series includes multiple data series associated with different items or groups of items, or include multiple data series associated with different time sequences;
processing relationship information representing a plurality of relationships, with each relationship relating the items or groups of items or relating time sequences of different of the data series of a forecast, the plurality of relationships including at least one of:
a first time relationship associating elements of a first time sequence with elements of a second time sequence, and
a first group relationship associating a first group of items with multiple other groups or items,
the processing including forming a data representation of each relationship;
determining a set of data series requirements based on the received relationship information, the data series requirements including at least a first data series requirement relating a first set of data series to a second set of data series over times or intervals for a time sequence associated with said first and second sets of data series, and a second data series requirement relating values of multiple data series for each time or interval of a time sequence;
determining second forecasts comprising a plurality of data series,
wherein each data series of said second forecasts is associated with (a) an item or a group of items, and (b) a time sequence in which each item in the time sequence represents a point or an interval,
the determining of the second forecasts including executing a data processing procedure on a computer processor to determine the data series of said second forecasts based on the data series of the first forecasts and based the data representations of the relationships, the data processing procedure being configured for the data series of the second forecasts to satisfy the plurality of relationships and to best approximate the data series of the first forecasts according to a similarity criterion.

15. A system comprising:
a plurality of computer implemented forecasters;
a computer implemented forecast reconciler coupled to receive forecasts data from respective forecasters of the plurality of forecasters; and
a storage for relationship data comprising a set of data series requirements for use by the forecast reconciler;
wherein each forecaster of the plurality of forecasters is configured to independently determine a forecast of a first plurality of forecasts comprising a plurality of data series,
wherein each data series of said plurality is associated with (a) an item or a group of items, and (b) a time sequence in which each item in the time sequence represents a time or an interval, and
wherein said plurality of data series includes multiple data series associated with different items or groups of items, or include multiple data series associated with different time sequences;
where the forecast reconciler is configured processing relationship information representing
the processing including forming a data representation of each relationship;
wherein the system is configured to determine the set of data series requirements based on received relationship information, wherein the relationship information represents a plurality of relationships, with each relationship relating the items or groups of items or relating time sequences of different of the data series of a forecast, the plurality of relationships including at least one of a first time relationship associating elements of a first time sequence with elements of a second time sequence, and a first group relationship associating a first group of items with multiple other groups or items, the data series requirements including at least a first data series requirement relating a first set of data series to a second set of data series over times or intervals for a time sequence associated with said first and second sets of data series, and a second data series requirement relating values of multiple data series for each time or interval of a time sequence;
wherein the forecast reconciler is configured to determine second forecasts comprising a plurality of data series,
wherein each data series of said second forecasts is associated with (a) an item or a group of items, and (b) a time sequence in which each item in the time sequence represents a point or an interval,
the determining of the second forecasts including executing a data processing procedure on a computer processor to determine the data series of said second forecasts based on the data series of the first forecasts and based the data representations of the relationships, the data processing procedure being configured for the data series of the second forecasts to satisfy the plurality of relationships and to best approximate the data series of the first forecasts according to a similarity criterion.

16. A method for forecasting comprising:
executing one or more data processing procedures to form independent forecasts including at least one of (a) a first plurality of forecasts for a respective a plurality of overlapping subsets of a plurality of items and (b) a second plurality of forecasts for a respective plurality of overlapping time points or intervals;
forming a data representation of forecast constraints resulting from relationships arising from at least one of the overlapping subsets of the plurality of items and the overlapping time points or intervals; and
executing a reconciliation data processing procedure to process the independent forecasts and the data representation of the forecast constrains to form reconciled forecasts satisfying the forecast constraints and approximating the independent forecasts.

17. The method of claim 16, wherein the independent forecasts include both (a) the first plurality of forecasts and (b) the second plurality of forecasts.

18. The method of claim 16, wherein the reconciliation data processing procedure comprises an optimization procedure for reducing a difference between the independent forecasts and the reconciled forecasts.

19. The method of claim 18, wherein the forecast constraints are linear constraints and the optimization procedure comprises a Quadratic Programming procedure.

20. The method of claim 16, wherein executing the one or more data processing procedures to form the independent forecasts comprises executing one or more of regression, moving average, and neural network based procedures.

21. The method of claim 1, wherein the determining of the second forecasts includes processing the first forecasts and the data representing the relationships using the data processing procedure.

22. The method of claim 21, wherein determining the first forecasts comprises collecting historical data comprising measurement data for a plurality of items or a group of items at one or more time sequences and applying at least one forecasting data processing procedure to the collected historical data to yield the first forecasts, and wherein the data processing procedure for determining the second forecasts does not process the historical data.

23. The method of claim 4, further comprising automatically collecting historical sales information for a plurality of items, and determining the first forecasts from the historical sales information, and automatically making orders for stocking said items based on the second forecasts.

24. A method for processing a plurality of independently computed forecasts over a plurality of time sequences spanning a time interval and over a plurality of subsets of a plurality items, each forecast of the plurality of forecasts representing a prediction for a particular time sequence of the plurality of time sequences and a particular subset of items of the plurality of subsets such that the forecast comprises a predicted value for respective periods of the particular time sequence, and the predicted values of said forecast represent an aggregate value over all the items in the particular subset, the method comprising:
receiving the plurality of independent forecasts, said forecasts having been computed separately by a plurality of independent forecasters, wherein the plurality of independent forecasts comprises one or both of
(a) a first independent forecast and a second independent forecast each comprising predicted values over a first subset of items, with the first independent forecast comprising values over a first time sequence and the second independent forecast comprising values over a second time sequence, wherein at least some time period of the first time sequence overlaps with multiple time periods of the second time sequence, and
(b) a third independent forecast and a fourth independent forecast each comprising predicted values over a third time sequence, with the third independent forecast comprising values for a third subset of items and the fourth independent forecast comprising values for a fourth subset of items, wherein at least some items belong to both the third subset and the fourth subset;
storing values in a data array representing a plurality of relationships between forecasts including at least one of
(c) a relationship for a particular subset of items requiring that an aggregation of values for time periods in a forecast over one time sequence for said subset is equal to a value for another time period in a forecast over another time sequence for said subset, and
(d) a relationship for a particular time sequence requiring that a value for a time period of said time sequence for a forecast for a particular subset of items is equal to an aggregation of values for the time period for other forecasts of subsets of items in said particular subset; and
after having received the plurality of independent forecasts, and after having stored the values representing the relationships, processing the values of the independent forecasts to yield a plurality of reconciled forecasts that satisfy the plurality of relationships and that approximate the plurality of independent forecasts, wherein the processing of the values of the independent forecasts comprises
processing the values of the independent forecasts and the values in the data array to satisfy the relationships and while reducing an approximation error between the reconciled forecasts and the independent forecasts.

25. The method of claim 24, wherein the independent forecasters include forecasters that operate according to configurable parameters, and wherein the method further processing historical data to determine the values of configurable parameters for said forecaster, and producing the independent forecasts by the independent forecasters using said values of the configurable parameters, wherein at least the values of the configurable parameters for a first independent forecaster are determined independently of determining the values of the configurable parameters for a second independent forecaster.

26. A system for processing a plurality of independently computed forecasts over a plurality of time sequences spanning a time interval and over a plurality of subsets of a plurality items, each forecast of the plurality of forecasts representing a prediction for a particular time sequence of the plurality of time sequences and a particular subset of items of the plurality of subsets such that the forecast comprises a predicted value for respective periods of the particular time sequence, and the predicted values of said forecast represent an aggregate value over all the items in the particular subset, the system comprising:
means for receiving the plurality of independent forecasts, said forecasts having been computed separately by a plurality of independent forecasters, wherein the plurality of independent forecasts comprises one or both of
(e) a first independent forecast and a second independent forecast each comprising predicted values over a first subset of items, with the first independent forecast comprising values over a first time sequence and the second independent forecast comprising values over a second time sequence, wherein at least some time period of the first time sequence overlaps with multiple time periods of the second time sequence, and
(f) a third independent forecast and a fourth independent forecast each comprising predicted values over a third time sequence, with the third independent forecast comprising values for a third subset of items and the fourth independent forecast comprising values for a fourth subset of items, wherein at least some items belong to both the third subset and the fourth subset;
means for storing values in a data array representing a plurality of relationships between forecasts including at least one of
(g) a relationship for a particular subset of items requiring that an aggregation of values for time periods in a forecast over one time sequence for said subset is equal to a value for another time period in a forecast over another time sequence for said subset, and
(h) a relationship for a particular time sequence requiring that a value for a time period of said time sequence for a forecast for a particular subset of items is equal to an aggregation of values for the time period for other forecasts of subsets of items in said particular subset; and
means for, after having received the plurality of independent forecasts, and after having stored the values representing the relationships, processing the values of the independent forecasts to yield a plurality of reconciled forecasts that satisfy the plurality of relationships and that approximate the plurality of independent forecasts, wherein the processing of the values of the independent forecasts comprises
processing the values of the independent forecasts and the values in the data array to satisfy the relationships and while reducing an approximation error between the reconciled forecasts and the independent forecasts.
